(19) United States
(12) Patent Application Publication
(10) Pub. No.: US 2016/0267540 A1
(43) Pub. Date: Sep. 15, 2016

(54) SYSTEM FOR PROVIDING BEHAVIORAL ENGAGEMENT WITH A USER DEVICE

(71) Applicant: Medialytic, LLC, Pompano Beach, FL (US)

(72) Inventor: Carlos Garcia, Lakewood Ranch, FL (US)

(21) Appl. No.: 15/019,622

(22) Filed: Feb. 9, 2016

Related U.S. Application Data
(60) Provisional application No. 62/114,011, filed on Feb. 9, 2015.

(51) Int. Cl. G06Q 30/02; H04W 4/20; H04M 1/725; H04W 4/00

(52) U.S. Cl. CPC G06Q 30/0267; H04W 4/003; H04W 4/20; H04M 1/72522

(57) ABSTRACT

In a server device, a method for engaging user activity associated with a user device. The method includes receiving from a user device, by the server device, an event notification indicating an activity of an application executed by the user device. The method includes comparing, by the server device, the event notification to a trigger event criteria. The method includes, in response to detecting a correspondence between the event notification and the trigger event criteria, transmitting, by the server device, a reminder message to the user device, the reminder message related to the activity of the application executed by the user device.

### RELATED APPLICATIONS

This patent application claims the benefit of U.S. Provisional Application No. 62/114,011, filed on Feb. 9, 2015, entitled, “System for Providing Content to a User Device,” the contents and teachings of which are hereby incorporated by reference in their entirety.

### BACKGROUND

With the development of the Internet, users have been able to connect with each other in a variety of ways. For example, users can view and purchase goods in a number of forums, such as retail or merchant forums. Further, product or service sources and distributors, such as retailers or merchants, typically have user device applications that provide users with the ability to access the retailer via a user device, such as a mobile device (e.g., smartphone).

### SUMMARY

As provided above, retailers and other merchants, for example, can provide applications (i.e., apps) to be execute on user's mobile devices. However, while a number of users will typically install the application onto his user device, on average less than 20% of the users will return to engage the application. Further, users may engage the application for a period, such as by placing an item for purchase into a shopping cart, and then not complete the transaction. Over time, the user may forget having placed the item in the cart, which, from the retailer's perspective, can result in a lost sale.

By contrast to conventional merchant applications, embodiments of the present innovation relate to a system for providing behavioral engagement with a user device. In one arrangement, the system is configured to provide reminder messages to a user device in response to detecting a particular user behavioral activity level regarding an application executed by the user on their device. For example, in the case where the user utilizes the user device to place an item for purchase into a shopping cart associated with an application. In response to this activity, the user device transmits an event notification, such as a message having a time stamp, to a server device. In response to detecting a particular time lapse from the time stamp of the message, the server device transmits a reminder message to the user device, either as an in-application message or as an out-of-application message, such as an email, Short Message Service (SMS) message, or push notification or advertisement as the user explores the Internet using other mobile applications or visits websites. The reminder message is configured to reengage the user with respect to the application in an attempt to have the user complete the transaction.

In one arrangement, embodiments of the innovation relate to, in a server device, a method for engaging user activity associated with a user device. The method includes receiving from a user device, by the server device, a user behavioral event notification indicating an activity of a user in an application executed by the user device. The method includes comparing, by the server device, the event notification to a trigger event criteria. The method includes, in response to detecting a correspondence between the user behavior event notification and the trigger event criteria, transmitting, by the server device, a reminder message to the user device, the reminder message related to the user behavior activity in the application executed by the user device.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a content distribution system configured to exchange content between one or more user devices and a server device, according to one arrangement.

FIG. 2A illustrates a schematic representation of a content distribution system configured to exchange content between one or more user devices and a server device, according to one arrangement.

FIG. 2B illustrates a schematic representation of a content distribution system configured to exchange content between one or more user devices and a server device, according to one arrangement.

FIG. 3 illustrates a schematic representation of a content distribution system configured to exchange content between one or more user devices and a server device, according to one arrangement.

FIG. 4 illustrates a schematic representation of a content distribution system configured to exchange content between one or more user devices and a server device, according to one arrangement.

FIG. 5 illustrates an arrangement of a heat map associated with user interaction of the user device of FIG. 4, according to one arrangement.

### DETAILED DESCRIPTION

Embodiments of the present innovation relate to a system for providing behavioral engagement with a user device. In one arrangement, the system is configured to provide reminder messages to a user device in response to detecting a particular activity level regarding an application executed by the user device. For example, in the case where the user utilizes the user device to place an item for purchase into a shopping cart associated with an application. In response to this activity, the user device transmits a user behavior event notification, such as a message having a time stamp, to a server device. In response to detecting a particular time lapse from the time stamp of the message, the server device transmits a reminder message to the user device, either as an in-application message or as an out-of-application message, such as an email, Short Message Service (SMS) message, push notification or advertisement as the user explores the Internet using other mobile applications or visits websites. The reminder message is configured to reengage the user with respect to the application in an attempt to have the user complete the transaction.

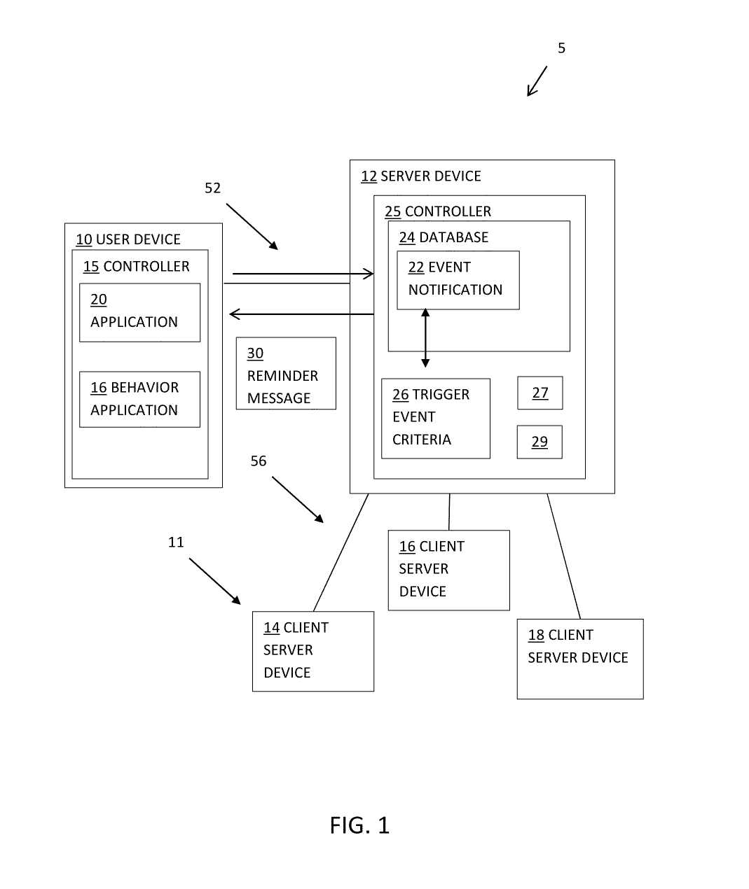

FIG. 1 illustrates a content distribution system 5 configured to exchange content between one or more user devices 10 and a server device 12, according to one arrangement.

As shown in FIG. 1, the user behavior notification system 5 includes a user device 10, such as a mobile phone (e.g., smartphone), a tablet device, a laptop computer, or other computerized device. The user device 10 includes a display, such as a touchscreen display configured to detect the location of a user's touch of the display. The user device 10 includes a controller 15, such as a memory and a processor and is disposed in electrical communication with a server device 12, such as via a network 52. The network 52 can be configured as either a wired or wireless wide-area network (WAN) or local-area network (LAN). The controller 50 of the user device 10 is configured to execute purchasing application 20, a description of which is provided below.

The server device 12 is configured as a computerized device having a controller 14, such as a memory and a processor. In one arrangement, the server device 12 is further disposed in electrical communication with a variety of client server devices 11 (e.g., client server devices 15, 16, 18 such as provided by various merchants, retailers, or mobile application developers) via a network 56 such as a wired or wireless WAN or LAN.

As indicated above, the client server devices 11 (e.g., retailers, other merchants, or mobile application developers) provide applications 20 for execution by user devices 10. However, while a number of users will typically install the application 20 onto his user device 10, on average less than 20% of the users will return to engage the application 20. As will be described below, the server device 12 is configured to engaging user behavior activity associated with the user device 10. The following provides a description of an example of the operation of the server device 12 when providing such engagement.

During operation, the server device 12 is configured to detect a user behavioral event associated with the activity or inactivity of an application 20 and provide the user device 10 with a reminder to direct the user back to using the application 20. With reference to FIG. 1, the user device 10 executes an application 20, such as a retail application as provided by a first client server device 14. Further, the user device 10 executes a behavioral application 16 which configures the user device 10 to detect a user behavioral activity level relative to the application 20.

For example, assume the case where the user activates the retail application 20 and places an item in a purchase cart provided by the application 20. In response to the activation of the application 20 and the placement of the item in the cart, the user device 10 provides a user behavior event notification 22 to the server device 12. The user behavior event notification 22 indicates an activity of the application 20 executed by the user device 10. While the user behavior event notification 22 can be configured in a variety of ways, in one arrangement, the user behavior event notification 22 is configured as a time stamp or a time and date stamp associated with the last user behavior activity of the application 20 executed by the user device 10.

In response to receiving the user behavior event notification 22, the server device 12 can store the user behavior event notification 22 in a database 24 and compare the user behavior event notification 22 to a trigger event criteria 26 provided by the first client server device 14. In response to detecting a correspondence between the user behavior event notification 22 and the trigger event criteria 26, the server device 12 is configured to transmit one or more reminder messages 30 to the user device 10 where the reminder message 30 is related to the user behavior activity of the application 20 executed by the user device 20. The reminder message is configured to direct the end-user of the user device to re-engage with the application 20.

For example, assume the trigger event criteria 26 instructs the server device 12 to send the user device 10 a reminder message 30 after a given period of inactivity relative to the retail application 20 (e.g., the item is in the shopping cart for longer than five minutes with no purchase activity). In such a case, the server device 12 is configured to detect a time lapse value 27 between a time associated with the time stamp 22 and a time 29 associated with the server device 12. For example, if the time stamp 22 has a value of 1:00 and the associated with the server device 12 has a value of 1:30, the server device 12 can detect the time lapse value as being equal to 0:30.

In the case where the server device 12 detects a correspondence between the time lapse value and the trigger event criteria 26 (e.g., the time lapse value 27 indicates that the item has been in the shopping cart for longer than six minutes with no purchase activity), the server device 12 transmits the reminder messages 30 to the user device 10, such as to remind the end-user that an item remains in the cart of the retail application 20.

The reminder messages 30 can be configured in a variety of ways. For example, the reminder messages 30 can be configured as an in-application message, where the reminder message 30 appears in conjunction with the application 20 as executed by the user device 10. In another example, the reminder message 30 can be configured as an out-of-application message, such as Short Message Service (SMS) message, a push notification, an email message or advertisement as the user explores the Internet using other mobile applications or visits websites. In one arrangement, the server device 12 is configured to provide the reminder message 30 to the user device 10 in substantially real-time. Such substantially real-time notification allows the server device 12 to attempt to adjust the behavior of the user of the user device 10 (e.g., to re-engage with an application executed by the user device 10) in a substantially immediate manner. For example, in the case where the application 20 is configured as a retail application 20, the server device 12 can direct a user of a user device 10 to reengage the retail application 20.

As provided above, the reminder message 30 is configured to provide the end user of the user device 10 with a reminder to reengage a previously-engaged application 20 executed by the user device 10. However, the reminder messages 30 can be configured in a variety of ways. In one arrangement, the reminder message 30 is configured as an advertisement message. With such an arrangement, the server device 12 can be configured to collect real-time commerce behavior associated with a user device 10 and to provide real-time messaging, such as advertisement messages, to the user device 10 based upon the detected commerce behavior.

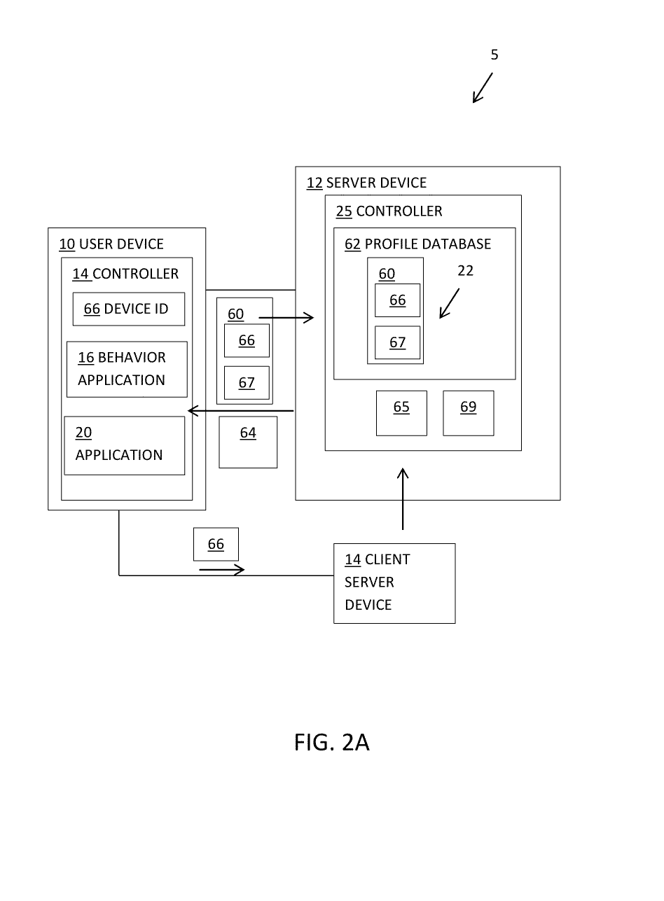

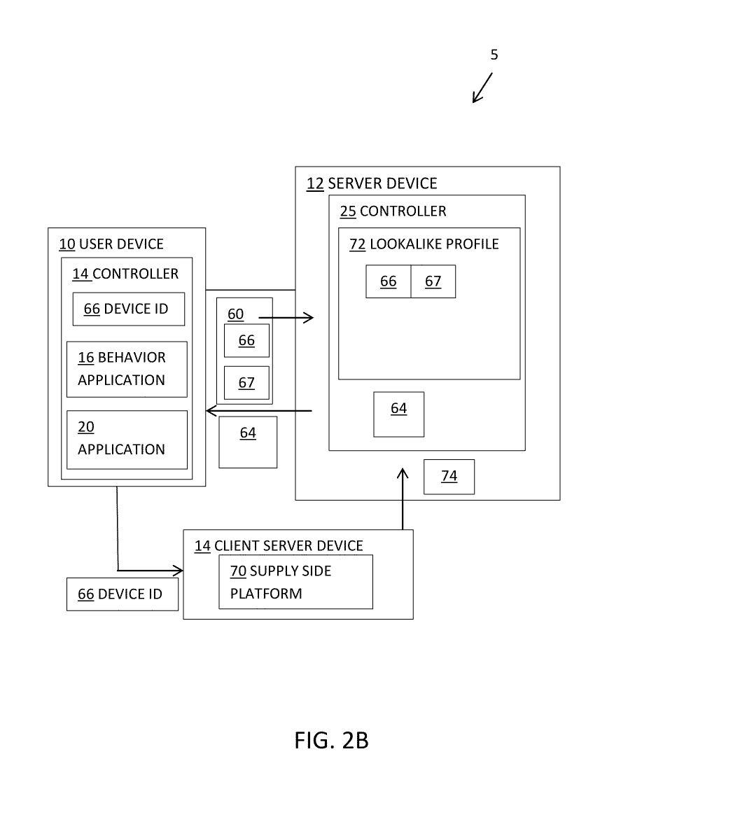

For example, with reference to FIG. 2A, as the user utilizes the user device 10 to search for products (e.g., such as via keyword searching), to add products to a watch list, purchase products or uses other mobile applications, the user device 10 is configured to generate, as the event notification 22, commerce behavior notification 60 associated with the user. In one arrangement, the commerce behavior notification 60 includes a user device identifier 66 along with an activity identifier 67, such as a listing of the search terms or activities associated with the user device 10. The user device 10 provides the commerce behavior notification 60 to server device 12, in real time, which, in turn, stores the commerce behavior notification 60 as an entry in a profile database 62.

The server device 12 is further configured to compare the activity identifier 67 of the commerce behavior notification 60 with a messaging criterion 65, such as provided by a client server device 11. For example, assume a retailer wants to send an advertisement message 64 regarding a sale on its pizza. The client server device 14 associated with the retailer transmits a messaging criterion 65 to the server device 12 to configure the server device 12. In the example case provided above, the messaging criterion 65 configures the server device 12 to review the profile database 62 for entries having an activity identifier 67 that identifies a relatively recent pizza-related search.

In the case where the server device 12 detects a correspondence between the activity identifier 67 of the commerce behavior notification 60 and the messaging criteria 65, the server device 12 is configured to transmit an advertisement message 64 to the user device 10 which is, related to the activity of the application 20 executed by the user device 10. For example, when the server device 12 detects one or more entries in the database 62 having a pizza related commerce behavior identifier 60, the server device 12 transmits the advertisement message 64 to the user devices 10 based upon the corresponding user device identifier 66. In such an arrangement, the client server device 14 can send the user devices 10 targeted advertisements based upon the user device 10 commerce behavior in real time.

As provided above, the server devise 12 is configured to transmit an advertisement message 64 to a user device 10 outside of the application 20 (e.g., while the user device 10 does not execute the application 20. In one arrangement, the server device 12 is configured to transmit an advertisement message 64 to a user device 10 while the user executes an application 20 associated with a client server device 14.

For example, with continued reference to FIG. 2A, assume the case where a user device 10 interacts with a client server device 14, such as associated with a retailer, via an application 20. As part of the interaction, the user device 10 provides a user device identifier 66 to the client server device 14. In response to receiving the user device identifier 66, the client server device 14 transmits a request 69 to direct a targeted advertisement message 64 to the server device 12. The request 69 includes the user device identifier 66 received from the user device 10. The server device 12 compares the user device identifier 66 of the request 69 with the user device identifiers 66 stored in profile database 62. In the case where the server device 12 detects a match between the user device identifier 66 of the request 69 with the user device identifiers 66 stored in profile database 62, the server device 12 accepts the targeted advertisement message 64 from the client server device 14 and forwards to the application 20 of the user device 10 while the user device executes the application 20.

With the user device 10 configured to detect commerce behavior associated with the user and to provide commerce behavior information to the server device 12, the user device 10 (e.g., a mobile device) is configured to execute a commerce behavior application and is not limited by relying on web cookies for tracking. This allows the server device 12 to gather a large volume of relatively high quality consumer user data information at a relatively granular level for a shopping recommendation engine. In one arrangement, based upon the consumer information, the server device 12 can be provide relatively efficient and precise product recommendations to the user device 10 as the user of the user device 10 accesses a network, such as the Internet, using other applications or other websites.

In one arrangement, with reference to FIG. 2B, the server device 12 is configured to provide an advertisement message 64 to a user device 10 based upon a lookalike profile 72 developed for the user device 10. As will be described below, with such a configuration, the server device 12 allows a client server device 14 provide the advertisement message 64 to the user device 10 when the user device 10 is interacting with the client server device 14 (e.g., looking to use a product or service offered by a client device end user), such as via an application 20, or visits other websites.

For example, as the user engages an application 20 executed by the user device 10, the behavior application 16 causes the user device 10 to transmit a commerce behavior notification 60 to the server device 12. The commerce behavior notification 60 identifies a user's behavior with respect to the application 20, such as when the user searches for a product, adds a product to a watch list, or purchases a product. For example, as indicated above, the commerce behavior notification 60 includes a user device identifier 66 as well as an activity identifier 67. The activity identifier 67 can include product purchase information, device identifier information (e.g., device brand), operating system, user geographic location information (e.g., city and/or state), user demographic information (e.g., user age), carrier information (e.g., VERIZON), etc.

As the server device 12 receives commerce behavior notification 60, the server device 12 reviews the commerce behavior notifications 60 for a defined segment of users associated with a defined event. For example, assume the case where the server device reviewed incoming commerce behavior notification 60 for a segment defined as” buyers” with an event defined as “purchases.” In the case where the server device 12 detects a commerce behavior notification 60 originating from a segment of buyers and associated with a purchase event, the server device 12 includes the commerce behavior notifications 60 (i.e., the user device identifier 66 and the activity identifier 67) as an entry within a lookalike profile 72 database. Accordingly, while the lookalike profile 72 can be configured in a variety of ways, in one arrangement, based upon the defined segment and the defined event, the lookalike profile database 72 includes entries that are associated with high value users. With such a lookalike profile database 72 developed by the server device 12, the server device 12 can direct targeted advertisement messages 64 from client server devices 14 to user devices 10, such as operated by high value users.

For example, with continued reference to FIG. 2B, assume the case where a user device 10 interacts with a client server device 14, such as associated with a retailer, via an application 20. As part of the interaction, the user device 10 provides a user device identifier 66 to the client server device 14. In response to receiving the user device identifier 66, a supply side platform 70, such as an advertisement server configured to sell advertisement messages 64, of the client server device 14 transmits a lookalike request message 74 to the server device 12. In one arrangement, the lookalike request message 74 requests the server device to review the lookalike profile 72 for an entry corresponding to the user device identifier 66 received from the user device 10. In the case where the server device 12 detects the presence of the user device identifier 66 in the lookalike profile database 72, the server device 12 is configured to receive an advertisement message 64 from the client server device 14 that is directed specifically toward the user of the user device 10. As illustrated, the server device 12 provides the targeted advertisement message 64 to the user device, either as an in-application message or as an out-of-application message as described above.

With such a configuration, the server device 12 allows a client server device 14 and supply side platform 70 to target particular user devices 10 (e.g., high value users of user devices 10) which interact with the client server device 14.

Retailers and other merchants distribute messages, such as advertisements, to users (e.g., user devices 10) in an attempt to increase the use of their mobile application or the sales of their goods or services. However, with conventional message distribution, the message may not maximize user engagement, conversion rates, or revenues. For example, in comparing two different messages from the same retailer for the same set of goods, one message can receive 8-10 times a higher response rate compared to the other message. In one arrangement, the server device 12 is configured to optimize distribution of a set of messages provided to a group of users based upon detected response rates.

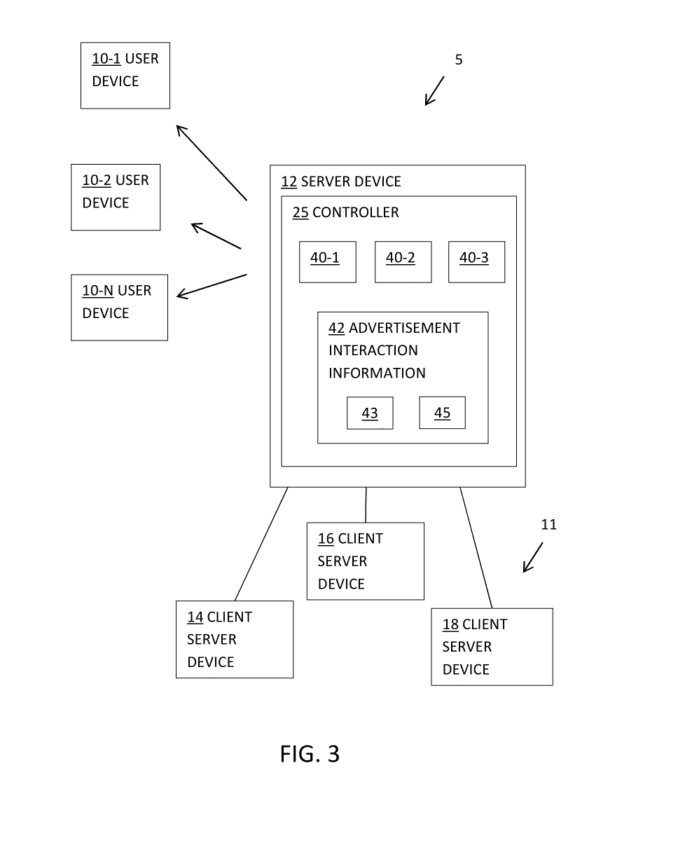

For example, with reference to FIG. 3, the server device 12 is provided with a set of messages 40-1, 40-2, 40-3, such as messages or advertisements, for the same item from a particular client server device 14. The server device 12 is configured to distribute the messages or advertisements to a set of user devices 10-1, 10-2, . . . , 10-N across the network. Such distribution is performed in a substantially even manner such that the server device 12 distributes 33.3% of the first message/advertisement 40-1, 33.3% of the second message/advertisement 40-2, and 33.3% of the third message/advertisement 40-3. As the user devices 10 interact with the respective messages/advertisements 40, the client server device 14 detects the interaction and calculates messages/advertisement interaction information 42, such as eCPM (effective cost per thousand) data 43 related to the messages/advertisements 40. Here, the messaging/advertisement interaction information or eCPM data 43 is defined as the amount earned by a message/advertisement based upon a total number of message/advertisement impressions or views.

The client server device 14 then provides messaging/advertisement interaction information 42, such as eCPM data 43 for the user devices 10-1, 10-2, . . . , 10-N to the server device 12. The server device 12 is configured to rank the messages/advertisements 40-1, 40-2, 40-3 based upon the messaging/advertisement interaction information 42, such as from highest eCPM to lowest eCPM. For example, assume the first message/advertisement 40-1 has an eCPM of $20.00, the second message/advertisement 40-2 has an eCPM of $10.00 and the third message/advertisement 40-3 has an eCPM of $2.00. Based on these results, the server device 12 ranks the first message/advertisement 40-1 as the most successful, the second message/advertisement 40-2 as moderately successful and the third message/advertisement 40-3 as relatively unsuccessful.

As a result of the rankings, the server device 12 is configured to distribute the messages/advertisements 40 to other sets of user devices 10, such as part of a second advertising/messaging campaign based upon the ranking. For example, the server device 12 can be configured to adjust the distribution percentages of the messages/advertisements 40 such that the server device 12 distributes the first message 40-1 to 80% of the user devices 10 and distributes the second message 40-2 to 20% of the user devices 10.

With such a configuration of the messages/advertisements 40, the server device 12 can optimize the response rate and revenue for a set of messages/advertisements 40.

In one arrangement, the content sever 12 can optimize a variety of aspects relating to the distribution of message/advertisements 40 to user devices. For example, the content server device 12 can be configured to optimize distribution of the messages/advertisements 40 based upon the likelihood that a user is using his user device 10. For example, each user device 10 can be configured to detect frequency information which identify the time at which the user device 10 accesses online product information. For example, assume the user device 10 accesses the Internet on Day 1 through Day 5 between the hours of 12:00 PM and 1:00 PM. The frequency information can identify this timeframe as being a high use or frequent use timeframe associated with the user device 10. In the case where the server device 12 receives frequency information 45 as the messaging/advertisement interaction information 42 from the client server device 14, the server device 12 is configured to distribute messages 40 to the user devices 40 at the times when the user is most likely present. With such distribution, the server device 12 is configured to optimize the response rate and revenue for a given set of messages.

In another example, using the above described techniques, the server device 12 is configured to optimize the sale price of a product or the distribution of a software application based upon its virality. In another example, using the above described techniques, the server device 12 is configured to optimize the messages 40 themselves (e.g., the content and/or the layout of the messages 40), such as based upon user device response.

Client server devices 11 provide software applications for use with user devices 10. These applications typically configure a touch sensitive display of the user devices 10 to provide a user interfaces (UIs) having a variety of configurations. However, different configurations of the layout of the UIs (e.g., button positioning, message positioning, etc.) can provide varying user engagement or conversion rates. In one arrangement, in order to optimize a UI configuration, the user device 10 is configured to detect screen tap interaction information and provide the information to the server device 12 for further analysis.

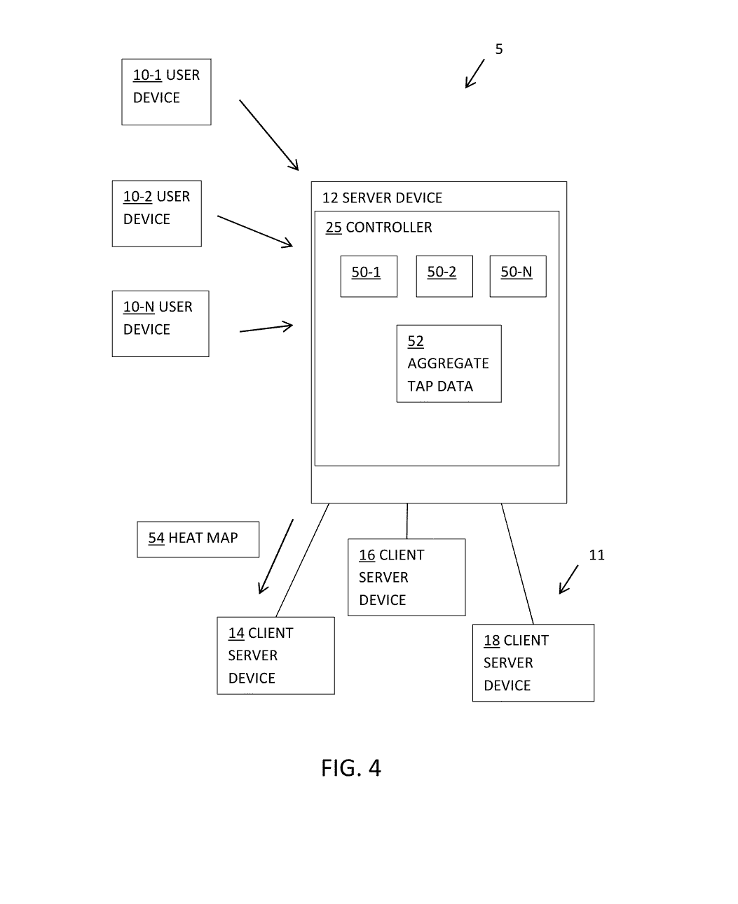

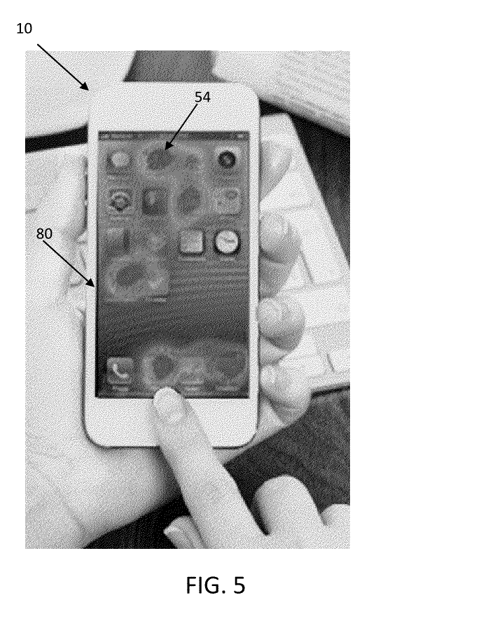

In one arrangement, with reference to FIG. 4, each user device 10 in the system 5 is configured to detect tap information for a given UI. For example, assume the case where each user device 10-1 through 10-N in the system 5 is configured to execute an application provided by a first client server device 14 and to display an identical UI on a touch sensitive screen associated with each user device 10. With additional reference to FIG. 5, as a user interacts with the UI for the application, such as by tapping various portion of a screen 60, the user device 10 detects screen tap interaction information 82. For example, each user device 10 can detect a Cartesian coordinate location on the screen where the user taps the UI. In another example, each user device 10 can detect a number of times a given location of the UI was tapped by the user. Over time, each user device 10 transmits their respective screen tap interaction information 50-1, 50-2, 50-N to the server device 12. In another example the screen tap interaction information 50 is configured as a video of the user device screen showing the user's interaction with the UI over a given period of time.

The server device 12 is configured to receive the screen tap interaction information 50 associated with user interaction with a display 80 of the user device 10. The server device 12 is further configured to aggregate the screen tap interaction information 50-1, 50-2, 50-N over a time period to generate aggregate tap data 52 associated with a given UI. The server device 12 can then generate a heat map 54, such as shown in FIG. 4 based upon the location and frequency of the users' interaction with the UI.

The server device 12 is then configured to generate a heat map 54, showing the location and frequency of the users' interaction with the UI, to the client server device 14. This allows an end-user (e.g., merchant or retailer) to determine to maintain or change the layout of the UI based upon the information from the heat map 54.

In one arrangement, rather than aggregating the screen tap interaction information 50-1, 50-2, 50-N, the server device 12 generates individual heat maps 54 based upon each received screen tap interaction information 50-1, 50-2, 50-N from each user. The server device 12 provides the individual heat maps 54 to the client server device 14 in real time to allow the end-user to quickly make the right decisions regarding the layout of the UI. Such an arrangement of the system 5 allows the end-user to reconfigure UIs as needed to increase user engagement and retention for a given application.

While various embodiments of the innovation have been particularly shown and described, it will be understood by those skilled in the art that various changes in form and details may be made therein without departing from the spirit and scope of the innovation as defined by the appended claims.

What is claimed is:

1. In a server device, a method for engaging user behavior activity associated with a user device, comprising:
receiving from the user device, by the server device, an event notification indicating an activity of an application executed by the user device;
comparing, by the server device, the event notification to a trigger event criteria; and
in response to detecting a correspondence between the event notification and the trigger event criteria, transmitting, by the server device, a reminder message to the user device, the reminder message related to the activity of the application executed by the user device.

2. The method of claim 1, wherein transmitting the reminder message to the user device, comprises transmitting, by the server device, the reminder message as a substantially real-time reminder message to the user device.

3. The method of claim 1, wherein:
receiving from the user device the event notification indicating the activity of the application executed by the user device comprises receiving from the user device, by the server device, an event notification having a time stamp associated with the last activity of the application executed by the user device;
comparing the event notification to the trigger event criteria comprises:
detecting, by the server device, a time lapse value between a time associated with the time stamp and a time associated with the server device, and
comparing, by the server device, the time lapse value to the trigger event criteria; and
transmitting the reminder message to the user in response to detecting the correspondence between the event notification and the trigger event criteria comprises, in response to detecting the correspondence between the time lapse value and the trigger event criteria, transmitting, by the server device, the reminder message to the user device, the reminder message related to the activity of the application executed by the user device.

4. The method of claim 1, wherein:
receiving from the user device the event notification indicating an activity of the application executed by the user device comprises receiving from the user device, by the server device, a commerce behavior notification that includes a user device identifier and an activity identifier;
comparing the event notification to a trigger event criteria comprises comparing, by the server device, the activity identifier of the commerce behavior notification to a messaging criteria; and
transmitting the reminder message to the user in response to detecting the correspondence between the event notification and the trigger event criteria comprises, in response to detecting a correspondence between the activity identifier of commerce behavior notification and the messaging criteria, transmitting, by the server device, an advertisement message to the user device, the advertisement message related to the activity of the application executed by the user device.

5. The method of claim 4, wherein transmitting the advertisement message to the user device comprises transmitting, by the server device, a first advertisement message to at least one first user device and a second advertisement message to at least one second user device as part of a first advertisement campaign; and
further comprising:
receiving, by the server device, advertisement interaction information based upon interaction of the at least one first device with the first advertisement message and interaction of the at least one second device with the second advertisement message,
ranking, by the server device, the first advertisement message and the second advertisement message based upon the advertisement interaction information, and
distributing, by the server device, the first advertisement message and the second advertisement message to a set of user devices as part of a second advertisement campaign based upon the ranking.

6. The method of claim 5, wherein the advertisement interaction information comprises an amount earned by an advertisement based upon a total number of advertisement views.

7. The method of claim 4, comprising:
detecting, by the server device, frequency information associated with the user device, the frequency information identifying a time of user activity relative to the user device; and
wherein transmitting the advertisement message to the user device comprises transmitting, by the server device, the advertisement message to the user device based upon the frequency information, the advertisement message related to the activity of the application executed by the user device.

8. The method of claim 1, further comprising:
receiving, by the server device, screen tap interaction information associated with user interaction with a display of the user device;
aggregating, by the server device, the screen tap interaction information over a time period; and
generating, by the server device, a heat map associated with the aggregated screen tap interaction information.

9. A server device configured to engage user activity associated with a user device, comprising:
a controller having a memory and a processor, the controller of the server device configured to:
receive from the user device an event notification indicating an activity of an application executed by the user device;
compare the event notification to a trigger event criteria; and
in response to detecting a correspondence between the event notification and the trigger event criteria, transmit a reminder message to the user device, the reminder message related to the activity of the application executed by the user device.

10. The server device of claim 9, wherein when transmitting the reminder message to the user device, the controller is configured to transmit the reminder message as a substantially real-time reminder message to the user device.

11. The server device of claim 9, wherein:
when receiving from the user device the event notification indicating the activity of the application executed by the user device, the controller is configured to receive from the user device an event notification having a time stamp associated with the last activity of the application executed by the user device;
when comparing the event notification to the trigger event criteria, the controller is configured to:
detect a time lapse value between a time associated with the time stamp and a time associated with the server device, and
compare the time lapse value to the trigger event criteria; and
when transmitting the reminder message to the user in response to detecting the correspondence between the event notification and the trigger event criteria, the controller is configured to in response to detecting the correspondence between the time lapse value and the trigger event criteria, transmit the reminder message to the user device, the reminder message related to the activity of the application executed by the user device.

12. The server device of claim 9, wherein:
when receiving from the user device the event notification indicating an activity of the application executed by the user device, the controller is configured to receive from the user device a commerce behavior notification that includes a user device identifier and an activity identifier;
when comparing the event notification to a trigger event criteria, the controller is configured to compare the activity identifier of the commerce behavior notification to a messaging criteria; and
when transmitting the reminder message to the user in response to detecting the correspondence between the event notification and the trigger event criteria, the controller is configured to in response to detecting a correspondence between the activity identifier of commerce behavior notification and the messaging criteria, transmit an advertisement message to the user device, the advertisement message related to the activity of the application executed by the user device.

13. The server device of claim 12, wherein when transmitting the advertisement message to the user device, the controller is configured to transmit a first advertisement message to at least one first user device and a second advertisement message to at least one second user device as part of a first advertisement campaign; and
wherein the controller is configured to:
receive advertisement interaction information based upon interaction of the at least one first device with the first advertisement message and interaction of the at least one second device with the second advertisement message,
rank the first advertisement message and the second advertisement message based upon the advertisement interaction information, and
distribute the first advertisement message and the second advertisement message to a set of user devices as part of a second advertisement campaign based upon the ranking.

14. The server device of claim 13, wherein the advertisement interaction information comprises an amount earned by an advertisement based upon a total number of advertisement views.

15. The server device of claim 12, wherein the controller is configured to:
detect frequency information associated with the user device, the frequency information identifying a time of user activity relative to the user device; and
when transmitting the advertisement message to the user device, the controller is configured to transmit the advertisement message to the user device based upon the frequency information, the advertisement message related to the activity of the application executed by the user device.

16. The server device of claim 9, the controller is further configured to:
receive screen tap interaction information associated with user interaction with a display of the user device;
aggregate the screen tap interaction information over a time period; and
generate a heat map associated with the aggregated screen tap interaction information.
